(19) United States
(12) Patent Application Publication
(10) Pub. No.: US 2006/0009067 A1
(43) Pub. Date: Jan. 12, 2006

(54) Connector with wire cover and wire cover therefor

(76) Inventors: Kazushige Sakamaki, Tokyo (JP); Atsushi Nishida, Aichi (JP); Masato Minakata, Aichi (JP); Hiroshi Kobayashi, Aichi (JP)

Correspondence Address: BARLEY SNYDER, LLC, 1000 WESTLAKES DRIVE, SUITE 275, BERWYN, PA, 19312, US

(21) Appl. No.: 11/180,749

(22) Filed: Jul. 13, 2005

(30) Foreign Application Priority Data
Jul. 12, 2004 (JP) 2004-205022

(51) Int. Cl. H01R 13/62

(52) U.S. Cl. 439/468

(57) ABSTRACT

A connector assembly comprises a connector and a wire guide. The connector has a lock arm. The lock arm includes a lock member for engaging a lock engaging member on a mating connector and a release member for disengaging the lock member from the lock engaging member. The wire cover is mounted to the connector. The wire cover has a wire receiving opening for bunching and guiding a wire toward the connector. The wire cover includes an opening that provides access to the release member. A finger support section is formed on a wall defining the opening. The finger support section faces the connector and the release member.

### FIELD OF THE INVENTION

The invention relates to a connector assembly including a connector mounted with a wire cover that bunches and guides wires in a predetermined direction. The connector includes a lock arm for disengaging the connector from a mating connector.

### BACKGROUND OF THE INVENTION

In conventional connector assemblies, wires extend from a front surface of a connector and are fitted to a mating connector at a front surface thereof. The connector has a lock arm that engages with a lock engaging member provided on the mating connector at a time of mating. The lock engaging member is operated by a user's finger to release the engagement. Some of the connectors additionally include wire covers for bunching and guiding the wires in a predetermined direction.

One example of a connector assembly including connector and a wire cover is disclosed in Japanese Patent Laid-open No. 9-92378. During disengagement of the connector assembly from a mating connector, the connector is gripped by a user near the mating connector while the user's finger releases the engagement of the connector from the mating connector by pressing on the lock arm. The recent miniaturization of electrical devices, however, requires the connectors, which are used in the devices, to also be miniaturized. It is therefore difficult if not impossible to grip the connector and press the lock arm without disturbing the wire cover during disengagement.

### SUMMARY OF THE INVENTION

It is therefore an object of the invention to provide a connector assembly with a connector and a wire cover that can be miniaturized without reducing the ability to disengage the connector assembly from a mating connector.

This and other objects are achieved by a connector assembly comprising a connector and a wire guide. The connector has a lock arm. The lock arm includes a lock member for engaging a lock engaging member on a mating connector and a release member for disengaging the lock member from the lock engaging member. The wire cover is mounted to the connector. The wire cover has a wire receiving opening for bunching and guiding a wire toward the connector. The wire cover includes an opening that provides access to the release member. A finger support section is formed on a wall defining the opening. The finger support section faces the connector and the release member.

### BRIEF DESCRIPTION OF THE DRAWINGS

FIG. 1 is a perspective view of a connector assembly according to the invention;

FIG. 2(a) is a top perspective view of a wire cover of the connector assembly of FIG. 2;

FIG. 2(b) is a bottom perspective view of the wire cover;

FIG. 3(a) is a bottom view of the wire cover;

FIG. 3(b) is a side view of the wire cover;

FIG. 4(a) is a top perspective view of a connector of the connector assembly of FIG. 1; and

FIG. 4(b) is a bottom perspective view of the connector.

### DETAILED DESCRIPTION OF THE INVENTION

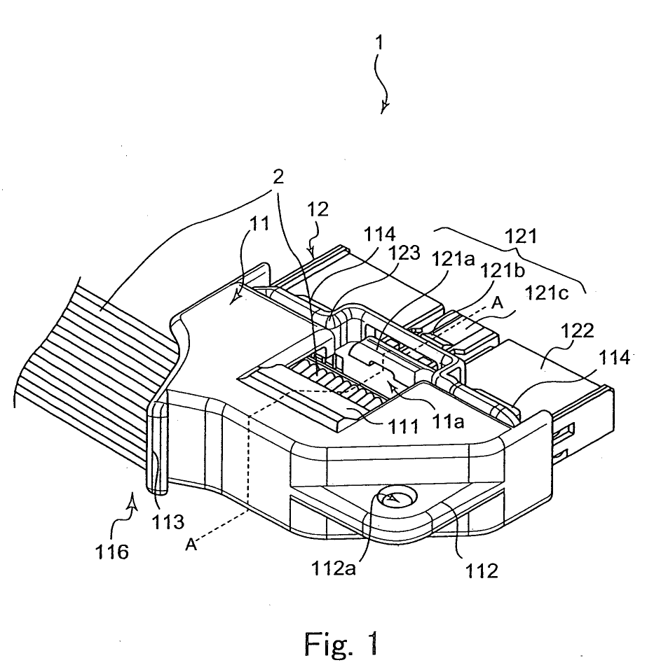

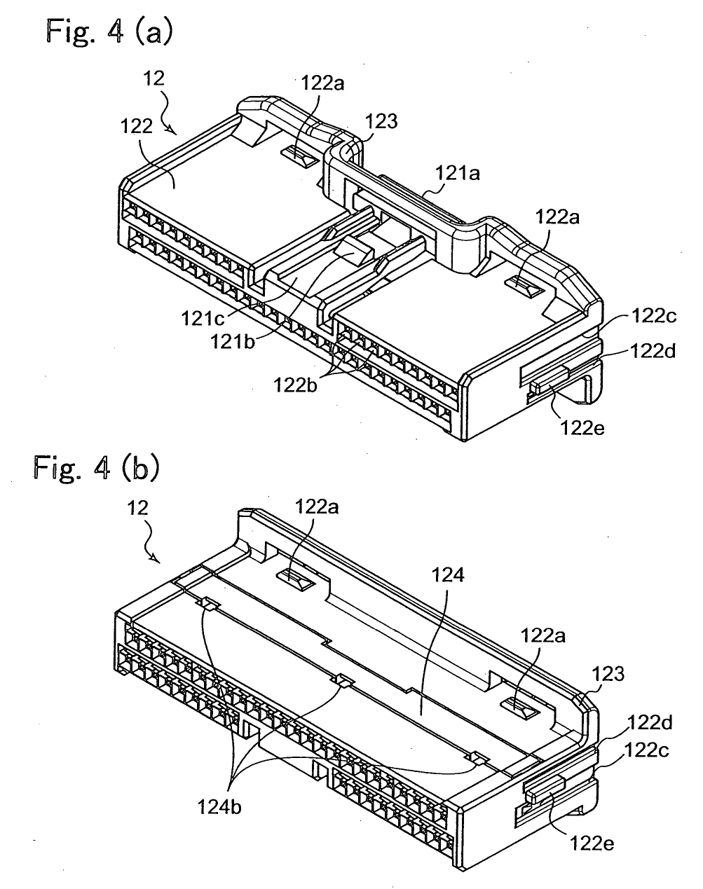

FIG. 1 shows a connector assembly 1. The connector assembly 1 includes a wire cover 11 mounted to a rear surface of a connector 12. As shown in FIG. 4(a), the connector includes a housing 122. The housing 122 has terminal receiving ports 122b that accommodate terminals (now shown). The terminals (now shown) are crimped to wires 2 and are electrically connected to mating terminals (not shown) in a mating connector (not shown) that are received in the terminal receiving ports 122(b) when the mating connector (now shown) is fitted to a front surface of the connector 2.

As shown in FIGS. 4(a)-4(b), wire cover mounting projections 122a extend from top and bottom surfaces of the housing 122. A guard member 123 extends from the top and bottom surfaces and is formed to protect the wire cover mounting projections 122a. A locking groove 122c, a temporary locking groove 122d, and a projection 122e are formed on a side of the housing 122. A retainer 124 is arranged on the bottom surface and has apertures 124b. The locking groove 122c and the temporary locking groove 122d confirm the position of the retainer 124 when the terminals (not shown) are inserted into the terminal receiving ports 122b from a rear surface of the connector 12. The retainer 124 moves between a pre-locked position and a locked position. FIG. 4(b) shows the retainer 124 in a state where the terminals (not shown), which, for example, have a lower wire connection, are in a locked state in the housing 122. Because the retainer 124 is well known in the art, the retainer 124 and the operation thereof will not be described in greater detail herein.

As shown in FIG. 1, the connector 12 has a lock arm 121 provided on a front surface thereof. As shown in FIG. 4(a), the lock arm 121 includes a release member 121a, a lock member 121b, and a resilient arm 121c. The lock member 121b is formed to engage with a lock engaging member (not shown) on the mating connector (not shown) at the time of mating. The release member 121a formed on the resilient arm 121c can be formed to be pressed downward to release the engagement of the lock engaging member (not shown) from the lock member 121b. The release member 121a may be, for example, formed to be operated by a user's finger to release the engagement thereof.

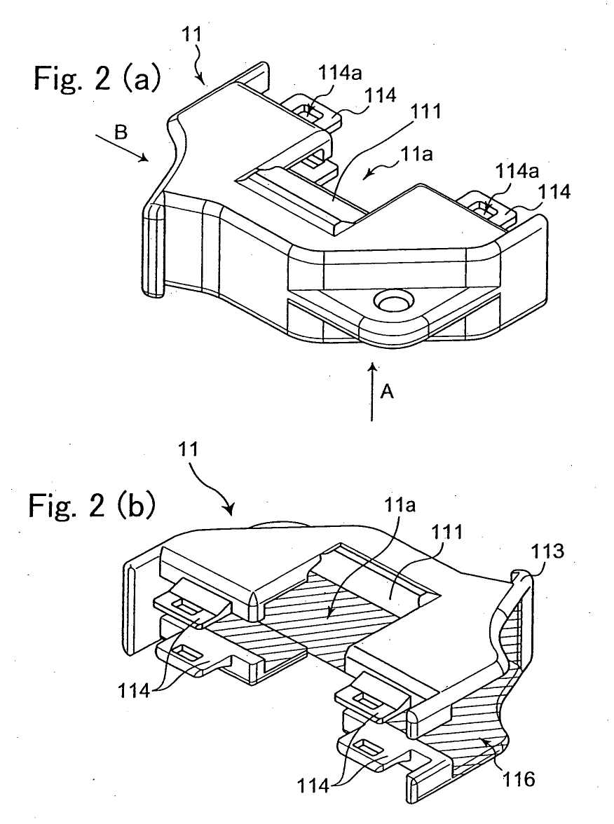

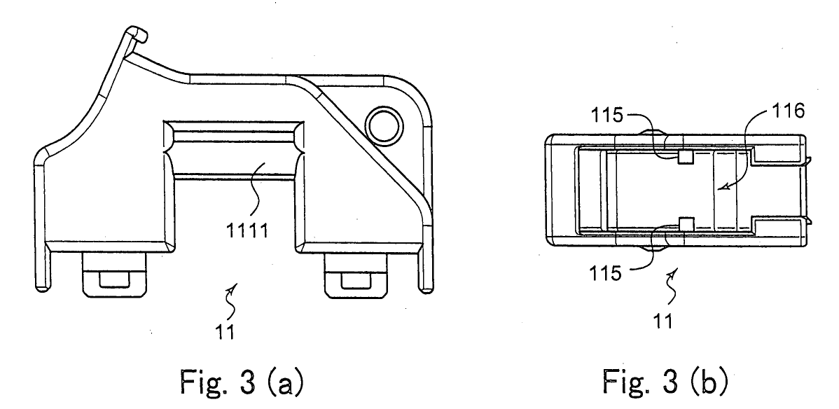

As shown in FIG. 1, the wire cover 11 includes an opening 11a. The opening 11a is formed so that the user's finger can access the release member 121a. The wires 2 held by the connector 12 can be seen from the opening 11a. As shown in FIG. 2, a finger support section 111 is formed at a wall facing the connector 12 among walls which define the opening 11a. The finger support section 111 has a substantially curved surface, which is recessed along the shape of a thickest part of the user's finger and supports the user's finger while accessing the release member 121a via the opening 11a from the top surface of the connector 12. As shown in FIG. 3(a), the wire cover 11 includes a second finger support member 1111. The second finger support member 1111 has substantially the same shape as the finger support member 111. The second finger support member 1111 supports the user's finger when the user's finger accesses the release member 121a of the lock arm 121 from the bottom surface of the connector 2.

As shown in FIG. 2(b), the wire cover 11 has a wire receiving opening 116 through which the wire is inserted. A fixing member 113 extends proximate the wire receiving opening 116 and fixes the wires 2 to the wire receiving opening 116. As shown in FIG. 1, an extension 112 extends from the wire cover 11 and is provided with a through-hole 112a for temporarily placing the wire cover 11 in a wire harness state. The wire cover 11 has attachment members 114 formed with mounting aperture 114a that correspond to the projections 122a of the connector 12, as shown in FIGS. 2(a), 4(a), and 4(b). As shown in FIG. 3(b), ribs 115 are formed on an inner surface of the wire cover 11 for reinforcing the wire cover 11. A mounting section 114 mounts the wire cover 11 to the connector 12.

During assembly, the terminals are crimped to the wire 2. The wire cover 11, which has the wire extending from the wire receiving opening 116, is mounted to the connector 12 by engaging the projections 122a on the connector 12 with the mounting apertures 114a provided on the attachment members 114. The terminals (not shown) are inserted into the rear side of the connector assembly 1 and are guided in a predetermined direction by the wire cover 11 into the terminal receiving ports 122b. Because the connector 12 and the wire cover 11 are reliably engaged at four spots, for example, even if only the wire cover 11 is pulled when the connector assembly 1 is to be removed from the mating connector (now shown), the connector 12 and the wire cover 11 remain engaged.

Because the wire cover 11 includes the finger support member 111 that supports the user's finger, the force applied to the wire cover 11 by the user's finger when the user's finger accesses the release member 121a to remove the connector assembly 1 from the mating connector (not shown), can be effectively utilized as the force removing the connector assembly 1 from the mating connector (not shown). Thus, the force that the user's finger applies to the wire cover 11 to remove the connector assembly 1 from the mating connector (now shown) can be utilized more effectively. Therefore, according to the connector assembly 1 according to the invention, even when the connector assembly is miniaturized, the connector assembly 1 may be easily removed from the mating connector (not shown) without reducing operability.

In the illustrated embodiment, the finger support member 111 and the second finger support member 1111 are disposed on the top surface and the bottom surface, respectively, of the wire cover 11. However, if only the finger support member 111 is included, the effect of the invention is not decreased. Additionally, although the finger support member 111 and the second finger support member 1111 have a substantially curved surface along the thickest part of the user's finger, the finger support member 111 and the second finger support member 1111 may be any shape capable of supporting the user's finger.

I claim:

1. A connector assembly, comprising:
a connector having a lock arm, the lock arm including a lock member for engaging a lock engaging member on a mating connector and a release member for disengaging the lock member from the lock engaging member;
a wire cover mounted to the connector, the wire cover having a wire receiving opening for bunching and guiding a wire toward the connector, the wire cover including an opening that provides access to the release member; and
a finger support section formed on a wall defining the opening, the finger support section facing the connector and the release member.

2. The connector assembly of claim 1, wherein the lock arm is arranged on a front surface of the connector and the wire cover is arranged on a rear surface of the connector.

3. The connector assembly of claim 1, wherein the finger support member has a substantially curved surface.

4. The connector assembly of claim 1, wherein the substantially curved surface is recessed.

5. The connector assembly of claim 1, wherein the finger support member is formed on the wire cover.

6. The connector assembly of claim 1, wherein the finger support member is provided adjacent to a top surface of the connector and a second finger support member is provided adjacent to a bottom surface of the connector.

7. The connector assembly of claim 1, wherein the connector has wire cover mounting projections formed on a top and bottom surface thereof and the wire cover has mounting apertures that engage the projections to mount the wire cover to the connector.

8. The connector assembly of claim 7, wherein the connector includes a guard member formed adjacent to the wire cover mounting projections.

9. The connector assembly of claim 1, wherein the release member is formed on a resilient arm.

10. The connector assembly of claim 1, wherein the connector includes terminal receiving ports.

11. The connector assembly of claim 1, wherein the connector includes a retainer.

12. The connector assembly of claim 1, wherein the wire cover includes a fixing member that extends proximate the wire receiving opening for fixing the wires.

13. The connector assembly of claim 1, the wire cover includes ribs formed on an inner surface thereof.
